(19) United States
(12) Patent Application Publication
(10) Pub. No.: US 2005/0111699 A1
(43) Pub. Date: May 26, 2005

(54) Suite of parking regulation control systems

(76) Inventor: Emil Gran, Bronx, NY (US)

Correspondence Address: EMIL GRAN, 3196 CAMBRIDGE AVENUE, BRONX, NY, 10463, US

(21) Appl. No.: 10/719,964

(22) Filed: Nov. 24, 2003

(51) Int. Cl. G06K 9/00

(52) U.S. Cl. 382/104

(57) ABSTRACT

A digital camera and laser-based distance-measuring device are mounted on a patrol vehicle, street sweeping vehicle, or in a handheld harness. The patrol is performed along a route of parked vehicles to determine if any of them are in violation of parking regulations. Information about the offending vehicle is visually captured, recorded, and transferred via wireless communication to another site for further processing. For distance-based parking violations, visual data capture may include an image of a vehicle bumper in combination with a fire hydrant, driveway or other point of reference along with a super-imposed numerical readout of the measuring device to indicate that the offending vehicle is parked outside the limits of acceptability. For time-based parking violations, the image may be a combination of a parking sticker or registration from the windshield, a license plate from the front or rear of the vehicle, an image of the parking meter next to the vehicle, and can be overlaid with text indicating the date, time. The flexibility of the system allows for multiple images to be combined in a manner that best captures the information required by the municipality to clearly indicate the culpability of the offending vehicle. Violations addressed are parking time limit expiration, illegal parking due to location restrictions, vehicle registration expiration, and violation of vehicle parking distance relative to various points of reference.

### BACKGROUND OF THE INVENTION

1. Field of the Invention

This invention relates to the enforcement parking regulations, particularly to motor vehicles that violate proximity restriction to points of reference such as fire hydrants, restricted parking zones, driveways, etc., and motor vehicles that violate parking times (both metered and posted).

2. Background

Regulations are enacted to control the parking of motor vehicles in various municipalities. Methods of restricting parking include the placement of parking meters and the display of signage near the curbing. Violations of parking regulations deprive municipalities of revenue from parking meters and significantly affect the ability of street sweeping and sanitation in larger cities. Parking abuse also deprives other vehicles of the legitimate use of parking spaces. Additionally, manual enforcement of parking regulations in dangerous neighborhoods often puts law enforcement personnel at risk when required to leave the safety of the patrol or street sweeping vehicle.

Safety

Officers patrolling by themselves in dangerous neighborhoods expose themselves to potential injury when they leave their vehicle and are focused on parking violators. This invention allows the officer to remain with in the relative safety of their patrol vehicle.

Cost savings

Current procedures have patrol cars either preceding or accompanying street sweeping vehicles. These patrol cars travel slowly and must make frequent stops to issue parking violations, often interfering with the flow of traffic in congested urban environments. Control of this new parking enforcement system is accomplished entirely by the operator of the street sweeping vehicle and completely eliminates the need for additional patrol cars and traffic or law enforcement officers.

### BRIEF SUMMARY OF THE INVENTION

The present invention overcomes the problems associated with enforcing parking regulations by assisting and automating the manual processes performed by a Parking Enforcement Officer. The evidence provided by images and measurement improves the accuracy and timeliness in the issuing and collection of citations resulting in a greater efficiency and revenue. The ability to collect data without the need to leave the patrol or street sweeping vehicle significantly reduces the time over manual methods. Additionally, when mounted on a street sweeping vehicle, the need for an additional patrol vehicle is eliminated, thus reducing cost to municipalities.

### BRIEF DESCRIPTION OF THE SEVERAL VIEWS OF THE DRAWINGS

FIG. 1 is a block diagram of a computer system and sensors, according to a preferred embodiment of the present invention.

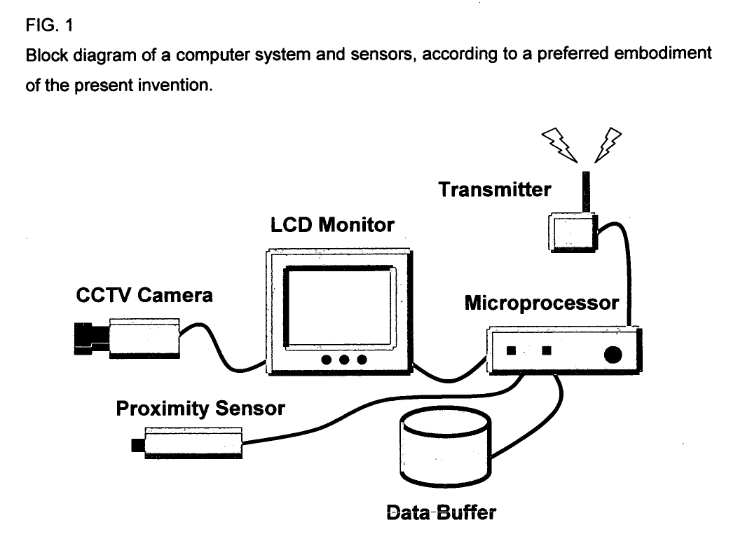

FIG. 2 is a block diagram of data communication path summary.

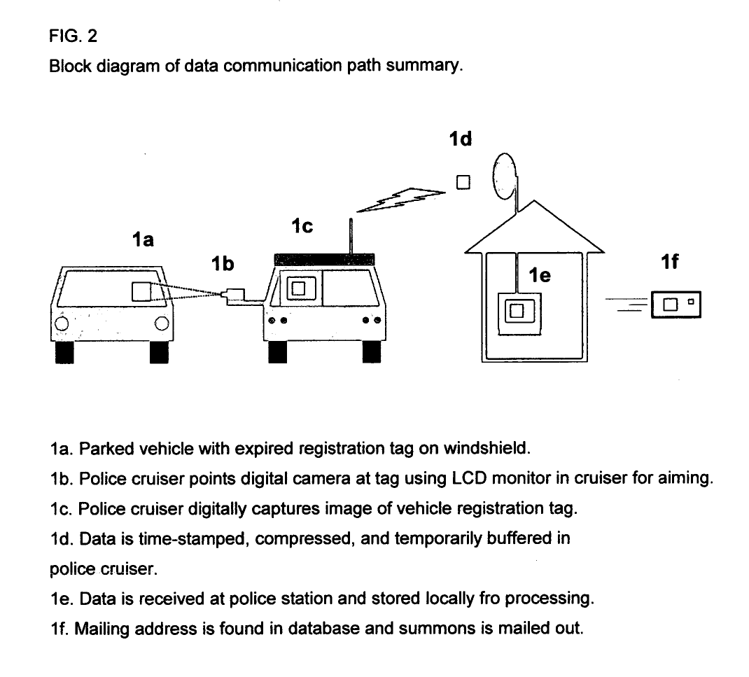

### DETAILED DESCRIPTION OF THE INVENTION

Visual data is obtained via a CCTV camera mounted externally that is controlled from within the patrol vehicle or as a self-contained handheld system. A small video monitor is used to confirm the position of the camera and a manually operated trigger initiates the capture of the data. Several images, the number of which can be user-defined, are combined and simultaneously displayed in the video monitor in a split screen format, which is then stored in a local database for upload. Time stamps and distance measurements can automatically be added to the image if the user chooses the setup option to include them. This data is later used for generation of a parking citation.

1. A suite of parking regulation control systems for capturing visual and numerical information about a parked vehicle, the system comprising:
a laser-based distance measuring device mounted on the outside of the patrol or street sweeping vehicle, or within a handheld unit;
a waterproof miniature closed-circuit television camera mounted on the outside of the patrol or street sweeping vehicle, or within a handheld unit;
a housing to contain both measuring device and camera;
a positioning arm to which the housing is mounted that can be aimed from within the patrol or street sweeping vehicle;
a video monitor mounted inside the patrol or street sweeping vehicle to display captured images and indicate what the camera is aimed at;
a memory device in the patrol or street sweeping vehicle to capture, combine, and store individual still frames of the video data, along with date and time;
a means for manually triggering the capture of a still frame of video data.

2. The parking regulation control system, as recited in claim 1, further comprising:
a proximity sensor for measuring distances between a parked vehicle and a point of reference;
a means of setting a threshold for the proximity sensor to indicate a distance violation;
a visual indication in the video monitor of the proximity value and when a threshold has been exceeded;
a coupling of proximity data with the video data that is also captured.

3. The parking regulation control system, as recited in claim 1, further comprising:
a memory device in the patrol or street sweeping vehicle for temporary holding and combining multiple captured images;
a switch on the housing to select the number of images to be combined in the composite image;
an output from the memory device for display of the combined image on a single monitor;
a data storage device in the patrol or street sweeping vehicle for taking the combined image data and storing it;
a means for manually triggering the storage of combined images from the memory device to the storage device.

4. The parking regulation control system, as recited in claim 1, further comprising:
a data processing module for executing software applications;
a character recognition application for the conversion of graphics data to text data;
a means for automatically initiating the character recognition application.

5. The parking regulation control system, as recited in claim 1, further comprising:
a wireless communication system device for transferring stored data from the patrol or street sweeping vehicle to another site;
a means for initiating the transfer of data from the patrol or street sweeping vehicle.

6. The parking regulation control system, as recited in claim 1, wherein the video target is a license plate number of the parked vehicle.

7. The parking regulation control system, as recited in claim 1, wherein the video target is a parking-permit on the parked vehicle.

8. The parking regulation control system, as recited in claim 1, wherein the video target is a motor vehicle registration sticker of the parked vehicle.

9. The parking regulation control system, as recited in claim 1, wherein the video target is a display window of a parking meter.

10. The parking regulation control system, as recited in claim 1, wherein the video target is a partial or full view of the parked vehicle.

11. The parking regulation control system, as recited in claim 1, wherein the video target is a fire hydrant or any other point of reference.

12. The parking regulation control system, as recited in claim 1, further comprising a camera-aiming mechanism to control pan, tilt, zoom from within the patrol or street sweeping vehicle.

13. The parking regulation control system, as recited in claim 1, wherein the camera-aiming mechanism has a telescoping extension arm on the outside of the patrol or street sweeping vehicle.

14. The parking regulation control system, as recited in claim 2, wherein the proximity target is a vehicle relative to a fire hydrant.

15. The parking regulation control system, as recited in claim 2, wherein the proximity target is a vehicle relative to a curb.

16. The parking regulation control system, as recited in claim 2, wherein the proximity target is a vehicle relative to a driveway.

17. The parking regulation control system, as recited in claim 2, wherein the proximity target is a vehicle relative to a restricted parking zone.

18. The parking regulation control system, as recited in claim 2, wherein the proximity target is a vehicle relative to a street corner.

19. The parking regulation control system, as recited in claim 2, wherein the proximity target is a vehicle relative to any other point of reference.

20. The parking regulation control system, as recited in claim 2, further comprising a proximity device mounting-bracket located on the exterior of the patrol vehicle.

21. The parking regulation control system, as recited in claim 3, further comprising a display coupled to the memory device, the display showing the first captured image on one side of the screen and the second image on the other side of the screen.

22. The parking regulation control system, as recited in claim 3, wherein the memory device overlays the display with text indicating the date and time.

23. The parking regulation control system, as recited in claim 3, wherein the memory device overlays the display with text indicating a proximity value and violation threshold.

24. The parking regulation control system, as recited in claim 3, wherein the number of memory device overlays can be adjusted.

25. The parking regulation control system, as recited in claim 3, wherein the number of memory device overlays is set by a dial or switch on the housing.

26. The parking regulation control system, as recited in claim 4, further comprising a data processing module coupled to the memory device.

27. The parking regulation control system, as recited in claim 4, wherein the character recognition engine target is a license plate.

28. The parking regulation control system, as recited in claim 4, wherein the character recognition engine target is a vehicle registration.

29. The parking regulation control system, as recited in claim 4, wherein the character recognition engine target is a parking permit.

30. The parking regulation control system, as recited in claim 4, wherein the character recognition engine target is a parking meter.

31. The parking regulation control system, as recited in claim 3, wherein the memory device overlays the display with text indicating the output of the character recognition engine.

32. The parking regulation control system, as recited in claim 5, wherein the data communication module is coupled to the memory device.

33. The parking regulation control system, as recited in claim 5, wherein the memory device transfers information to the communication module in one or more formats that are compatible with third-party systems.

34. The parking regulation control system, as recited in claim 5, wherein the data communication module sends license plate data to third-party systems for verification of whether or not a vehicle is stolen.

35. The parking regulation control system, as recited in claim 5, wherein the data communication module receives verification of whether or not a vehicle is stolen based on information previously sent.

36. The parking regulation control system, as recited in claim 5, wherein the data communication module sends composite image data to another site for generation of parking citations.

37. A method for enforcing parking regulations comprising:
capturing an image of a parked vehicle;
capturing second of the vehicle, parking meter, hydrant, or other reference points;
combining all images along with text;
storing the combined data in the patrol or street sweeping vehicle;
transferring the stored data to another site;
generating a traffic citation;
billing the customer based on the type of violation incurred.

38. The method for enforcing parking regulations, as recited in claim 35, further comprising the steps of:
comparing the proximity of the parked vehicle with one or more fixed reference points; and
overlaying the proximity value as text on the combined image data.

39. The method for enforcing parking regulations, as recited in claim 35, further comprising the steps of:
analyzing images for characters; and
overlaying the characters as text on the combined image data.

40. The method for enforcing parking regulations, as recited in claim 35, further comprising the steps of:
extracting combined data from data storage device of the patrol or street sweeping vehicle, and sending it to the communication module;
sending data from the communication module by wireless means to another site;
removing the locally stored data from the patrol or street sweeping vehicle upon verification from the communication module that data has been successful transferred; and
generating a parking citation.
